(19) United States
(12) Patent Application Publication
(10) Pub. No.: US 2014/0265569 A1
(43) Pub. Date: Sep. 18, 2014

(54) TRANSIENT ASSIST USING STARTING BATTERY IN VARIABLE SPEED GENSET

(71) Applicant: CATERPILLAR INC., Peoria, IL (US)

(72) Inventors: Dachuan Yu, Normal, IL (US); Eric Matthew Andris, Dunlap, IL (US); Gregory J. Speckhart, Peoria, IL (US)

(73) Assignee: CATERPILLAR INC., Peoria, IL (US)

(21) Appl. No.: 13/832,755

(22) Filed: Mar. 15, 2013

(51) Int. Cl. H02J 3/00

(52) U.S. Cl. CPC H02J 3/00
USPC 307/24; 307/64

(57) ABSTRACT

A variable speed genset system is provided. The variable speed genset system may include a primary power source, an electric machine, an energy storage device for starting the primary power source and a boost converter. The electric machine may be mechanically coupled to the primary power source and electrically coupled to one or more loads through a common bus. The boost converter may be in electrical communication with each of at least the common bus and the energy storage device, and configured to selectively communicate power from the energy storage device to the common bus if a bus voltage of the common bus falls to a predetermined lower limit.

### TECHNICAL FIELD

The present disclosure generally relates to variable speed gensets, and more particularly, to systems for controlling an electric machine of a genset during transient conditions.

### BACKGROUND

Electric machines, such as induction machines, switched reluctance machines, and other comparable types of electric machines, are commonly used in the industry to convert electrical energy into rotational torque or rotational torque into electrical energy for any one of a variety of different applications including machine tools, traction motors, industrial work machines, stationary drive machines, mobile work vehicles, hybrid electric vehicles, and the like. Electric machines are commonly employed in association with a primary power source, such as an internal combustion engine or any other comparable prime mover, to provide a combined genset which serves to generate electrical and/or mechanical energy.

As shown by example in FIG. 1, the architecture of a traditional variable speed genset 10 typically provides a primary power source 12 that is mechanically and/or rotatably coupled to a rotor of the electric machine 14, while the stator of the electric machine 14 is in turn electrically coupled to a common bus 16 of the associated vehicle, machine and/or tool. Specifically, the common bus 16 typically includes a rectifier 18 which converts AC voltage at the output of the electric machine 14 into DC bus voltage. The common bus 16 further provides an inverter 20 and appropriate filters 22 to convert the DC bus voltage into AC voltage, or the like, that is usable by one or more loads 24 of the machine.

In a generating mode of operation, the primary power source 12 may mechanically rotate the rotor of the electric machine 14 to cause electromagnetic interactions between the rotor and the stator of the electric machine 14 and to generate electrical energy which may be stored or employed by one or more connected loads 24. Moreover, in typical variable speed gensets 10, the operating speed of the primary power source 12 is varied according to the demands of the loads 24, as shown for example in FIG. 2. For instance, in order to accommodate for an increase in load demand, the engine speed can be increased to increase the electrical power that is produced by the electric machine 14. Alternately, if the load demand is reduced, the engine speed can be decreased to conserve fuel.

One area of improvement associated with traditional variable speed gensets 10 pertains to the manner of operating the genset 10 during transient or step load conditions while engine speeds are relatively low. During such conditions, the power output by a genset 10 at low engine speeds may be insufficient on its own to maintain desirable operation of each connected load 24. Accordingly, traditional gensets 10 typically employ a secondary energy storage device, such as the ultracapacitor 26 of FIG. 1, which is provided in addition to the starter battery 28 for the genset 10. For example, the ultracapacitor 26 or similar devices may discharge at approximately 130-200 VDC, which may then be converted by a nominal boost converter 30 into approximately 300-700 VDC to match the bus voltage of the common bus 16. The additional energy supplied by the ultracapacitor 26 is then applied to the bus voltage to assist the electric machine 14 in supporting the connected loads 24.

However, adding a separate and secondary energy storage device such as an ultracapacitor introduces substantial increases in costs and weight to the overall variable speed genset and associated machine or work tool. The additional weight can further translate into increased fuel consumption and decreased efficiency. Moreover, incorporating secondary energy storage devices takes up additional space on the associated vehicle, machine or tool which can be better suited for other use. The present disclosure is directed at addressing one or more of the deficiencies set forth above.

### SUMMARY OF THE DISCLOSURE

In one aspect of the present disclosure, a variable speed genset system is provided. The variable speed genset system may include a primary power source, an electric machine, an energy storage device for starting the primary power source, and a boost converter. The electric machine may be mechanically coupled to the primary power source and electrically coupled to one or more loads through a common bus. The boost converter may be in electrical communication with each of at least the common bus and the energy storage device, and configured to selectively communicate power from the energy storage device to the common bus if a bus voltage of the common bus falls to a predetermined lower limit.

In another aspect of the disclosure, a transient assist system for a variable speed genset having a primary power source, an electric machine, a common bus and an energy storage device. The transient assist system may include a boost converter having an input and an output, a first interface electrically coupling the input of the boost converter to the energy storage device, and a second interface electrically coupling the output of the boost converter to the common bus. The second interface may be configured to electrically communicate the output voltage to the common bus when the bus voltage falls to a predetermined lower limit.

In yet another aspect of the disclosure, a variable speed genset system is provided. The variable speed genset system may include a primary power source, an electric machine mechanically coupled to the primary power source, a rectifier circuit electrically coupled to the electric machine, an inverter circuit electrically coupled to the rectifier circuit and forming a common bus therewith, a starter battery for starting the primary power source, and a high boost ratio boost converter electrically disposed between the starter battery and the common bus. The high boost ratio converter may be configured to boost an input voltage received from the starter battery to an output voltage to the common bus which substantially approximates a bus voltage of the common bus.

### BRIEF DESCRIPTION OF THE DRAWINGS

FIG. 1 is a diagrammatic view of the traditional architecture of a variable speed genset of the prior art;

FIG. 2 is a graphical view of the normalized power output of a traditional variable speed genset of the prior art as a function of engine speed;

FIG. 3 is a diagrammatic view of one exemplary variable speed genset system constructed in accordance with the teachings of the present disclosure; and

FIG. 4 is a flow diagram of one exemplary method of controlling a variable speed genset system.

### DETAILED DESCRIPTION

Reference will now be made in detail to specific embodiments or features, examples of which are illustrated in the accompanying drawings. Generally, corresponding reference numbers will be used throughout the drawings to refer to the same or corresponding parts.

FIG. 3 diagrammatically illustrates one exemplary electric drive or variable speed genset system 100 that may be employed in conjunction with industrial work machines, stationary drive machines, mobile work vehicles, hybrid electric vehicles, machine tools, and the like. As shown, the variable speed genset 100 may generally include a primary power source 102, an electric machine 104, a rectifier circuit 106, an inverter circuit 108, a common bus 110 disposed between the rectifier circuit 106 and the inverter circuit 108, and one or more loads 112 associated with the variable speed genset 100. The variable speed genset system 100 may additionally include a filter 114 for conditioning power sourced to one or more of the loads 112, as well as a pre-existing energy storage device 116, such as a starter battery, or the like, used for starting the primary power source 102 until the genset 100 is able to sustain operation on its own.

The primary power source 102 may include an internal combustion engine or any other comparable prime mover suitable for outputting mechanical energy, such as rotational torque at an output shaft thereof. The electric machine 104 may employ an induction machine, a switched reluctance machine, or any other suitable electric motor or generator commonly used in the art. For example, the electric machine 104 may include a rotor that electromagnetically interacts with and is rotatably disposed within a stator such that electrical input at the stator generates mechanical or rotational output at the rotor, as in a motoring mode of operation, or alternately, mechanical or rotational input at the rotor generates electrical energy at an output of the stator, as in a generating mode of operation. Moreover, the rotor of the electric machine 104 may be mechanically coupled to the output of the primary power source 102 and the stator may be electrically coupled to the common bus 110 through the rectifier circuit 106.

When operating in a generating mode of operation, as diagrammatically demonstrated in the genset system 100 of FIG. 3, the primary power source 102 may communicate a rotational torque at the input or rotor of the electric machine 104. As the rotor rotates within the stator of the electric machine 104, electrical power may be generated at the output of the stator and communicated to the rectifier circuit 106, which may further convert the AC voltage output by the electric machine 104 into DC voltage. The DC voltage may be communicated along the common bus 110 and to the inverter circuit 108 where the DC voltage may be converted into suitable AC voltage required by the connected loads 112. The AC voltage may further be at least partially conditioned by one or more appropriate filters 114 prior to sourcing the electrical power to the one or more loads 112.

Furthermore, the variable speed genset system 100 may be configured to vary the operating speed of the primary power source 102 and the connected electric machine 104 according to any changes in the load demand. During transient conditions or in the presence of step loads, however, the combination of the primary power source 102 and the electric machine 104 may be unable on its own to immediately source adequate power to the changing loads 112 as desired. Accordingly, the variable speed genset 100 may further include a transient assist system 200 as shown in FIG. 3 to passively supplement the electrical power supplied to the loads 112 as needed. More specifically, the transient assist system 200 may employ a DC to DC boost converter 202, such as a high boost ratio boost converter, or the like, configured to boost a first DC voltage, as provided by an existing energy source, such as a starter battery 116, into a second DC voltage that is significantly greater in magnitude than that of the first DC voltage and sufficient to be supplied to the common bus 110.

As shown in FIG. 3, for example, the boost converter 202 may include an input 204 for receiving the first DC voltage, and an output 206 for transmitting a second, boosted DC voltage. The transient assist system 200 may further include connecting circuitry, such as a first interface 208 for electrically coupling the input 204 of the boost converter 202 with the energy storage device 116, and a second interface 210 for electrically coupling the output 206 of the boost converter 202 with the common bus 110. For example, the first interface 208 may include circuitry configured to connect the input 204 of the boost converter 202 substantially parallel across the positive and negative, or ground, contacts of an existing starter battery 116, or the like, while the second interface 210 may include circuitry configured to connect the output 206 of the boost converter 202 in substantially parallel across the positive and negative, or ground, lines of the common bus 110.

Still referring to the embodiment of FIG. 3, one or both of the first and second interfaces 208, 210 may be configured to passively and automatically communicate an output DC voltage provided at the output 206 of the boost converter 202 to the common bus 110 when the bus voltage falls to a predetermined lower limit. In one implementation, for example, the transient assist system 200 may be configured to specifically output a DC voltage having a magnitude which approximates, but is slightly less than, a magnitude of the bus voltage of the common bus 110. The second interface 210 may then be passively configured such that the boost converter 202 automatically and substantially immediately supplies power to the common bus 110 whenever the bus voltage provided by the genset 100 falls to or below the predetermined output voltage of the boost converter 202, or the predetermined lower limit.

In addition, the output 206 and/or the second interface 210 of the transient assist system 200 may be electrically coupled relative to each of the output of the rectifier circuit 106 and the common bus 110 such that connected loads 112 are not negatively affected or impacted by any sudden deficiencies in the power output by the primary power source 102 and electric machine 104. Moreover, the transient assist system 200 may be disposed at the output of the rectifier circuit 106 and coupled directly to the common bus 110 such that the output voltage of the boost converter 202 is substantially isolated from the rectifier circuit 106. Furthermore, the second interface 210 may include an arrangement of one or more diodes that are coupled directly to the common bus 110 and configured to passively communicate any supplemental electrical power to the common bus 110 as needed, while preventing any substantial dissipation of the bus voltage in the common bus 110 through the boost converter 202.

In such a way, the transient assist system 200 may be passively but effectively implemented without the need of complex algorithms and/or additional hardware. In other modifications, the transient assist system 200 may be implemented as an actively engaging system within which one or more of the first and second interfaces 208, 210 of the transient assist system 200 may employ electronically engageable components, such as switches, gates, transistors, relays, or the like. However, such active systems would require additional control algorithms, hardware, and other considerations which may unnecessarily and undesirably add to the complexity and overall costs of implementation of the transient assist system 200 and the associated genset 100.

Furthermore, as implemented in FIG. 3, the variable speed genset system 100 may not only serve to replace an additional energy source, such as an ultracapacitor 26 of the prior art, or the like, but may further be minimally extended upon to eliminate other traditional components commonly associated with variable speed gensets. For example, through its connections to the common bus 110 via the transient assist system 200, a pre-existing starter battery 116 may be used to engage the electric machine 104 to start the primary power source 102, and thus, eliminate the need for a separate starter motor as traditionally held. Additionally, in transient assist systems 200 employing bi-directional DC to DC converters, electrical power along the common bus 110 may be at least partially applied to the pre-existing starter battery 116, and thus, eliminate the need for an alternator as commonly found in traditional electric drive vehicles, machines and/or tools.

Referring now to FIG. 4, the boost converter 202 and the connecting circuitry, such as the first and second interfaces 208, 210 coupling the boost converter 202 to the energy storage device 116 and the common bus 110, respectively, may be arranged and configured to operate according to the method 300 shown. As shown as step 300-1, the transient assist system 200 may be configured to engage, or supplement the bus voltage, only when there is a transient condition or when the bus voltage of the common bus 110 falls below a predetermined lower limit. The predetermined lower limit may be designated as a magnitude of DC voltage which approximates, but is slightly less than, the nominal magnitude of the bus voltage. Furthermore, the boost converter 202 may be passively configured to output a boosted voltage having a magnitude which approximates the predetermined lower limit such that the boosted voltage is always available to the common bus 110, but not necessarily engaged therewith unless the bus voltage supplied solely by the electric machine 104 falls to or below the predetermined lower limit.

For example, connecting circuitry 208, 210 of a boost converter 202 that is configured to output a voltage, V_{b,out}, with a magnitude that is slightly less than the bus voltage, or the output voltage of the rectifier circuit 106, V_{r,out}, may be passively arranged to automatically supply power to the common bus 110 when the bus voltage falls to or below a predetermined lower limit, V_{b,out}. In other words, when the bus voltage is greater than the predetermined lower limit, V_{r,out}>V_{b,out}, the electric machine 104 may supply power to any loads 112 connected to the common bus 110, and when the bus voltage falls to or below the predetermined lower limit, V_{r,out}≦V_{b,out}, the transient assist system 200 may at least temporarily supply power to the connected loads 112 from the energy storage device 116 until the electric machine 104 regains nominal operating speeds and output power. The corresponding drop in voltage as perceived by the loads 112, approximately V_{r,out}−V_{b,out}, may be preconfigured to be minimal so as not to adversely affect functionality of any connected loads 112.

Still referring to the method 300 of FIG. 4, if the bus voltage of the common bus 110 falls below such a predetermined lower limit, the transient assist system 200 may automatically supplement or supply the bus voltage to the common bus 110 through energy stored within the pre-existing energy storage device 116 as shown by steps 300-2 and 300-3 of FIG. 4. In particular, the connecting circuitry of the first interface 208 may be configured to source electrical power from the energy storage device 116 to the input 204 of the boost converter 202, while the boost converter 202 boosts the input voltage at a high boost ratio sufficient to produce an output voltage which approximates the nominal bus voltage of the common bus 110 as shown as step 300-2. Correspondingly, the connecting circuitry of the second interface 210 may be configured to source the boosted DC voltage provided at the output 206 of the boost converter 202 to the common bus 110 as shown as step 300-3 of FIG. 4. Moreover, the connecting circuitry 208, 210 of the transient assist system 200 may be implemented such that the boost converter 202 effectively sources the bus voltage only when the voltage generated by the electric machine 104 falls to or below the predetermined lower limit. Alternately, if there is no transient or step load condition found during step 300-1, the connecting circuitry 208, 210 of the transient assist system 200 may be configured to effectively prevent any transmission of power, or effectively disengage any existing transmission of power, from the boost converter 202 to the common bus 110 as in step 300-4.

### INDUSTRIAL APPLICABILITY

In general, the foregoing disclosure finds utility in various applications relating to the control of vehicles, machines and/or tools employing variable speed gensets. More specifically, the disclosed systems and methods may be used to provide more efficient control of electric machines typically used in association with electric or hybrid drive systems including machine tools, traction motors, industrial work machines, stationary drive machines, mobile work vehicles, hybrid electric vehicles, and the like.

In particular, the disclosed transient assist systems enable optimum control and performance of loads by automatically and immediately supplementing the common bus voltage in the presence of transient or step load conditions without requiring additional energy storage devices. Specifically, the present disclosure employs connections to a starter battery commonly found on traditional electric drive vehicles, machines and/or tools so as to eliminate the need for an additional energy source, such as an ultracapacitor, to supply power to the common bus during transient conditions.

In addition, the transient assist systems of the present disclosure may be implemented using relatively simple circuitry, such as an arrangement of one or more diodes, or the like, to effectively connect such pre-existing starter batteries to the common bus. By employing a passive configuration, the present disclosure further serves to eliminate the need for control algorithms, hardware, and other considerations which may unnecessarily and undesirably add to the complexity and overall costs of implementation of the transient assist system.

The transient assist systems disclosed herein also provide a basis upon which minor extensions and/or modifications can be made to further eliminate other pre-existing electric drive components and related hardware. For example, a bi-directional DC to DC converter may be used within the transient assist system to enable charging of the starter battery off of the bus voltage, and thus, eliminate the need for a traditional alternator. The transient assist system can also be used to effectively connect the starter battery to the electric machine and start the primary power source, and thus, eliminate the need for a traditional starter motor.

The present disclosure thus reduces complexity, costs, machine weight, and fuel consumption, while improving overall efficiency. The present disclosure further enables valuable space savings on the associated vehicle, machine and/or tool.

From the foregoing, it will be appreciated that while only certain embodiments have been set forth for the purposes of illustration, alternatives and modifications will be apparent from the above description to those skilled in the art. These and other alternatives are considered equivalents and within the spirit and scope of this disclosure and the appended claims.

What is claimed is:

1. A variable speed genset system, comprising:
a primary power source;
a variable speed generator mechanically coupled to the primary power source, the variable speed generator being electrically coupled to one or more loads through a common bus;
an energy storage device for starting the primary power source; and
a boost converter in electrical communication with each of at least the common bus and the energy storage device, the boost converter being configured to selectively communicate power from the energy storage device to the common bus if a bus voltage of the common bus falls to a predefined lower limit.

2. The system of claim 1, wherein the primary power source is an internal combustion engine, and the variable speed generator is a permanent magnet generator.

3. The system of claim 1, wherein the energy storage device is a starter battery.

4. The system of claim 1, further comprising a rectifier circuit electrically coupled to the variable speed generator and an inverter circuit electrically coupled to the rectifier circuit, the common bus being electrically disposed between the rectifier circuit and the inverter circuit.

5. The system of claim 4, wherein the rectifier circuit converts AC voltage into DC voltage, and the inverter circuit converts DC voltage into AC voltage.

6. The system of claim 4, further comprising a filter electrically coupled to the inverter circuit and configured to at least partially condition the AC voltage prior to transmission to the one or more loads.

7. The system of claim 1, wherein the boost converter is a DC to DC boost converter configured to boost a DC voltage supplied by the energy storage device into a DC voltage which approximates the DC bus voltage of the common bus.

8. The system of claim 1, wherein the boost converter is a high boost ratio boost converter that is configured to output a DC voltage having a magnitude that is slightly less than that of the DC bus voltage of the common bus, the predefined lower limit being set to the DC voltage output by the high boost ratio boost converter.

9. The system of claim 1, wherein the boost converter is coupled directly to the common bus through an arrangement of one or more diodes configured to prevent any substantial dissipation of the bus voltage of the common bus through the boost converter.

10. The system of claim 1, wherein the boost converter is further configured to automatically disengage electrical communication between the energy storage device and the common bus when the bus voltage exceeds the predefined lower limit.

11. A transient assist system for a variable speed genset having a primary power source, a variable speed generator, a common bus and an energy storage device, the transient assist system comprising:
a boost converter having an input and an output, the boost converter being configured to boost an input voltage received at the input to an output voltage at the output which substantially approximates a bus voltage of the common bus;
a first interface electrically coupling the input of the boost converter to the energy storage device; and
a second interface electrically coupling the output of the boost converter to the common bus, the second interface being configured to electrically communicate the output voltage to the common bus when the bus voltage falls to a predefined lower limit.

12. The system of claim 11, wherein the second interface includes an arrangement of one or more diodes coupled directly to the common bus and configured to prevent any substantial dissipation of the bus voltage through the boost converter.

13. The system of claim 11, wherein the predefined lower limit is slightly less than the bus voltage, and the output voltage of the boost converter is configured to approximate the predefined lower limit.

14. The system of claim 11, wherein the boost converter is a high boost ratio boost converter that is configured to output a DC output voltage having a magnitude that is slightly less than that of a DC bus voltage of the common bus.

15. The system of claim 11, wherein the boost converter and the second interface is configured to automatically disengage electrical communication between the boost converter and the common bus when the bus voltage exceeds the predefined lower limit.

16. A variable speed genset system, comprising:
a primary power source;
a variable speed generator mechanically coupled to the primary power source;
a rectifier circuit electrically coupled to the variable speed generator;
an inverter circuit electrically coupled to the rectifier circuit and forming a common bus therewith;
a high boost ratio boost converter electrically coupled to the common bus;
a starter battery for starting the primary power source electrically coupled to the high boost ratio boost converter; and
a controller in electrical communication with at least one of the primary power source, the variable speed generator, the common bus, and the high boost ratio boost converter to monitor for a transient load condition, and configured to enable electrical communication between the high boost ratio boost converter and the common bus if a bus voltage of the common bus falls to a predefined lower limit.

17. The system of claim 16, wherein the high boost ratio boost converter is a DC to DC boost converter configured to boost a DC voltage supplied by the starter battery into a DC voltage having a magnitude that is slightly less than that of a DC bus voltage of the common bus, the high boost ratio boost converter being coupled directly to the common bus through an arrangement of one or more diodes configured to prevent any substantial dissipation of a bus voltage of the common bus through the high boost ratio boost converter.

18. The system of claim 16, wherein the controller is further configured to automatically disengage electrical communication between the starter battery and the common bus when the bus voltage exceeds the predefined lower limit.

19. The system of claim 16, wherein the predefined lower limit is slightly less than the bus voltage, and an output voltage of the high boost ratio boost converter is configured to approximate the predefined lower limit.

20. The system of claim 16, wherein the rectifier circuit converts AC voltage into DC voltage, and the inverter circuit converts DC voltage into AC voltage, the system further comprising a filter electrically coupled to the inverter circuit and configured to at least partially condition the AC voltage prior to transmission to one or more loads.
